(19) United States
(12) Patent Application Publication
(10) Pub. No.: US 2023/0367668 A1
(43) Pub. Date: Nov. 16, 2023

(54) PROACTIVE ROOT CAUSE ANALYSIS

(71) Applicant: Computer Sciences Corporation, Ashburn, VA (US)

(72) Inventors: Marc OGLESBY, Arlington, TX (US); Nick TAMBURRO, Brunswick West (AU); Betty LAU, Richmond Hill (CA); Ya XUE, Chapel Hill, NC (US); Jun LIU, Cary, NC (US)

(73) Assignee: Computer Sciences Corporation, Ashburn, VA (US)

(21) Appl. No.: 18/314,649

(22) Filed: May 9, 2023

Related U.S. Application Data
(60) Provisional application No. 63/340,776, filed on May 11, 2022.

(51) Int. Cl. G06F 11/07; G06F 11/30

(52) U.S. Cl. CPC G06F 11/079; G06F 11/3075

(57) ABSTRACT

A method is provided in an example embodiment and may include receiving information identifying an anomaly or a predicted outage of a component of a system and requesting a data service for buffered data generated by the component within a timeframe of receiving the information. The method further may include normalizing the buffered data into discrete time units into corresponding distinct units of time and analyzing the buffered data using a machine learning (ML) model to identify a root cause of the anomaly or the predicted outage. The method further may include identifying at least one solution to the identified root cause based on characteristics associated with the root cause of the anomaly or the predicted outage and providing the at least one solution to an automation component to avoid onset of an event that triggers outage of the component or the system.

### CROSS REFERENCE TO RELATED APPLICATIONS

The instant application claims priority to U.S. Provisional Application 63/340,776 entitled PROACTIVE ROOT CAUSE ANALYSIS filed May 11, 2023, the contents of which are incorporated by reference herein in its entirety.

### FIELD OF THE INVENTION

Various embodiments described herein generally relate to methods and systems for proactive root cause analysis (RCA). More specifically, various embodiments relate to performing RCA in response to triggers generated within a network, where the triggers may correspond to an anomaly or a predicted problem within a network.

### BACKGROUND

Root cause analysis (RCA) is a technique used in many fields, including IT operations, to identify root causes of a problem i.e., the fundamental reasons that led to occurrence of the problem. Subsequently, based on the identified root causes, appropriate solutions are determined in order to solve the problem. Typically, whenever a problem occurs, a solutioning team or a service engineer spends considerable time to perform RCA and detail all the step-by-step findings in a report starting from the time the problem happened until solving the problem. Since the number of problems occurring in a time period and the corresponding nature, type, and criticality of each problem is unknown, hence the solutioning team or service engineer(s) cannot effectively manage their workload leading to extended time required to resolve the problem. Prolonged problem resolution time is inefficient and costly.

### SUMMARY

According to an embodiment of the invention, a method is disclosed. The method comprises: receiving information identifying an anomaly or a predicted outage of a component of a system; requesting a data service for buffered data generated by the component of the system within a timeframe of receiving the information; normalizing the buffered data into discrete time units into corresponding distinct units of time; analyzing the buffered data using a machine learning (ML) model to identify a root cause of the anomaly or the predicted outage; identifying at least one solution to the root cause of the anomaly or the predicted outage based on characteristics associated with the root cause of the anomaly or the predicted outage; and in response to the anomaly or the predicted outage, providing the at least one solution to an automation component to avoid onset of an event that triggers outage of the component or the system.

The above embodiment may include various optional features. The operations may further include normalizing events associated with an application or the system in the buffered data that are identified by a unique key, wherein analyzing the buffered data using the ML model identifies undetected characteristics associated with the events that are normalized over normalized time. The ML model may be configured to cluster the buffered data into a plurality of clusters and select a cluster based on characteristics associated with the cluster that identifies the root cause of the anomaly or the predicted outage.

According to an embodiment of the invention, a non-transitory computer readable media storing instructions programmed to cooperate with a processor to perform operations is disclosed. The operations comprise: receiving information identifying an anomaly or a predicted outage of a component of a system; requesting a data service for buffered data generated by the component of the system within a timeframe of receiving the information; normalizing the buffered data into discrete time units into corresponding distinct units of time; analyzing the buffered data using a machine learning (ML) model to identify a root cause of the anomaly or the predicted outage; identifying at least one solution to the root cause of the anomaly or the predicted outage based on characteristics associated with the root cause of the anomaly or the predicted outage; and in response to the anomaly or the predicted outage, providing the at least one solution to an automation component to avoid onset of an event that triggers outage of the component or the system.

The above embodiment may include various optional features. The operations may further include normalizing events associated with an application or the system in the buffered data that are identified by a unique key, wherein analyzing the buffered data using the ML model identifies undetected characteristics associated with the events that are normalized over normalized time. The ML model may be configured to cluster the buffered data into a plurality of clusters and select a cluster based on characteristics associated with the cluster that identifies the root cause of the anomaly or the predicted outage. The operations may further include receiving a report based on resolution of an issue, the report including metrics and other information stored in the data service and identifying a root cause that corresponds to at least one clusters of the plurality of clusters; updating a training dataset based on the report; and training an updated ML model based on the training dataset and an evaluation dataset.

According to an embodiment of the invention, a system is provided. The system includes a non-transitory computer readable media storing instructions, and a processor programmed to cooperate with the instructions to perform operations. The operations comprise: receiving information identifying an anomaly or a predicted outage of a component of a system; requesting a data service for buffered data generated by the component of the system within a timeframe of receiving the information; normalizing the buffered data into discrete time units into corresponding distinct units of time; analyzing the buffered data using a machine learning (ML) model to identify a root cause of the anomaly or the predicted outage; identifying at least one solution to the root cause of the anomaly or the predicted outage based on characteristics associated with the root cause of the anomaly or the predicted outage; and in response to the anomaly or the predicted outage, providing the at least one solution to an automation component to avoid onset of an event that triggers outage of the component or the system.

The above embodiment may include various optional features. The operations may further include normalizing events associated with an application or the system in the buffered data that are identified by a unique key, wherein analyzing the buffered data using the ML model identifies undetected characteristics associated with the events that are normalized over normalized time. The ML model may be configured to cluster the buffered data into a plurality of clusters and select a cluster based on characteristics associated with the cluster that identifies the root cause of the anomaly or the predicted outage. The operations may further include receiving a report based on resolution of an issue, the report including metrics and other information stored in the data service and identifying a root cause that corresponds to at least one clusters of the plurality of clusters; updating a training dataset based on the report; and training an updated ML model based on the training dataset and an evaluation dataset.

### DRAWINGS

Various embodiments in accordance with the present disclosure will be described with reference to the drawings, as follows.

FIG. 1 shows an embodiment of conducting Root Cause Analysis (RCA).

FIG. 2 shows an embodiment of conducting RCA using a machine learning (ML) model.

FIG. 3 shows a flowchart of an embodiment for using the ML model for RCA to provide solutions.

FIG. 4 shows a computer system for implementing the embodiments of the present disclosure.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring example embodiments.

References to one or an embodiment in the present disclosure can be, but not necessarily are, references to the same embodiment; and such references mean at least one of the embodiments.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented. The term “comprising” when utilized means “including, but not necessarily limited to”; it specifically indicates open-ended inclusion or membership in the so-described combination, group, series and the like. The term “a” means “one or more” unless the context clearly indicates a single element. The term “about” when used in connection with a numerical value means a variation consistent with the range of error in equipment used to measure the values, for which ±5% may be expected. “First,” “second,” etc., re labels to distinguish components or blocks of otherwise similar names but does not imply any sequence or numerical limitation. “And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

“Network” may refer to one or more components of one or more systems that are interconnected via communication paths. The network may include any number of software and/or hardware elements coupled to one another to establish the communication paths and route data/traffic via the established communication paths. Since a network may include one or more systems and one or more systems may correspond to a network, hence the terms “network” and “system” are used interchangeably throughout the disclosure. “Component” may comprise any component within the network or system that includes hardware, software, or combination of both. Each component can also include suitable interfaces for receiving, transmitting, and/or otherwise communicating data and/or information in a network environment. As non-limiting examples, the component includes at least one of: a server, a controller, a router, a switch, a controller, a service, an application, a database, and a storage. Further, the component may be a part of a wireless network infrastructure such as but not limited to access points (on-premises or cloud), edge platforms, and the like.

“Data pipeline” refers to an end-to-end process in which data is collected, extracted, modified, and delivered. Such pipelines may be used by any enterprise or business to move data from one or more sources such as databases, applications, and other sources to a destination in order to facilitate storage, transformation, and further processing.

“Event” refers to any activity within the network. The event may be general data for the network or specific data pertaining to one or more components within the network. The event may be associated with a timestamp and may be continuously generated similar to log data. “Incident” refers to specific activity data within the network that has a potential of causing a specific problem in the routine functioning of the component or network. Any alert, trigger, log data, event, or measurable metrics can be an incident. As a non-limiting example, incident may be a specific event or a collection of events that have a probability of causing the problem in the component or network. As another non-limiting example, the incident may be event(s) similar to one or more historical events that caused the problem within the network. As yet another non-limiting example, the incident may be specific data, indicating certain network activity, from a predictor that predicts probability of occurrence of the problem based on information contained in that data.

“Problem”, specifically within context of this disclosure, refers to any abnormal activity within the network that is a potential deterrent to the smooth functioning of the network. The problem may be detected or predicted. As a non-limiting example, the problem includes a full loss of service to one or more components within the network or to the network as a whole. As another non-limiting example, the problem includes a partial loss of service to the one or more components within the network or to the network as a whole. As yet another non-limiting example, the problem includes a degradation of service performance associated with one or more components within the network or the network as a whole. As yet another non-limiting example, the problem includes reduced or a decline in operational capacity of one or more components to a defined limit. As yet another non-limiting example, the problem includes a server outage detected or predicted within the network.

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

In conventional approaches, RCA is conducted only after a problem has occurred, typically using one type of data such as tracking incident data after an incident has happened. However, an objective of the present disclosure is to extract disparate information such as component details, metrics, logs, traces, events, incidents, changes, alerts, and other triggers together at one place in order to conduct RCA for not only detected but for predicted problems within a network as well. Using different data types to resolve the problem leads to more accurate solutions to a given problem than using a single data type. Further, conducting RCA proactively for predicted problems resolves the problem even before it occurs, thereby preventing downtime or inconvenience to users/customer/clients leading to business disruption.

Another objective of the present disclosure is to automatically extract data for remediating the detected or predicted problem to either self-heal the problem using automation or provisioning the availability of such data to accelerate or support solutioning team or service engineers in redressal of the detected or predicted problems. This approach saves time and is efficient as compared to manual resolution approach where the solutioning team or service engineer pulls out data step-by-step to identify solutions.

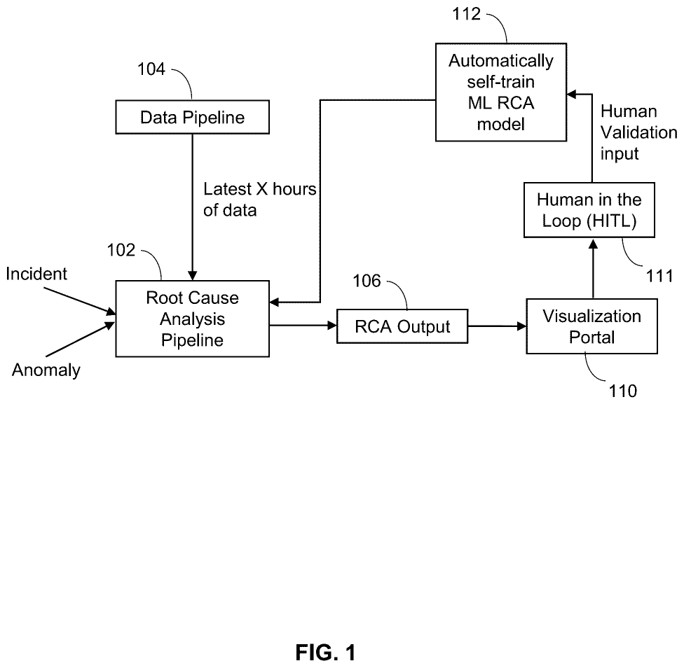

FIG. 1 shows an embodiment of conducting Root Cause Analysis (RCA). As illustrated in FIG. 1, two types of inputs may trigger an RCA pipeline 102, namely an incident and an anomaly. The incident may refer to a predicted problem or a detected problem within a network. As a non-limiting example, the incident may refer to a predicted server outage for a set of servers within the network. As another non-limiting example, an output of an outage prediction system, such as the one disclosed in the co-filed U.S. Provisional Application No. entitled titled METHOD AND SYSTEM FOR OUTAGE PREDICTION, may be utilized as an input to the RCA pipeline 102. The output of the above-mentioned outage prediction system may correspond to incidents that are potential candidates for causing any outage of a component. Incidents may be high severity issues that are generated when there is unplanned disruption to business services or applications at an enterprise level. This may refer to an alert indicating issues within the network. As a non-limiting example, when a metric such as Central Processing Unit (CPU) utilization is above the threshold of 95% for a component of a system then an alert is generated that is marked as an incident. The anomaly may refer to a signal indicating abnormal or unusual activity detected within the network. The anomaly may be independent of preset thresholds and may be generated proactively as soon as deviation from usual behavior of one or more metrics is observed. In a non-limiting example, considering CPU utilization as a metric, usual CPU utilization may be measured as 85% for a specific component of the system. However, on a specific day and time when the CPU utilization is measured as 92% then the unusual behavior is marked as an anomaly. Although FIG. 1 shows two types of inputs to the RCA pipeline 102. However, other inputs may also be considered for RCA analysis including but not limited to events and logs.

Incidents may be detected from multiple sources and may be used to trigger the RCA pipeline 102. Incidents created may correspond to incident numbers which may be retrieved from a data repository in a non-limiting example, where the data repository may provide incident number for incidents that have a configuration item (CI). Further, incidents may be predicted for probable problems such as outage to one or more components of Franthe network. Each input (an incident or an anomaly) may include a corresponding timestamp and triggers the RCA pipeline 102.

The RCA pipeline 102 receives the triggers such as the incident (detected and predicted) or anomaly. Once the RCA pipeline 102 is triggered, it either automatically or in response to request for buffered data, pulls or extracts data associated with the trigger from a data pipeline 104 within a time frame of receiving the trigger. The time frame may pertain to latest X hours of data such as but not limited to four hours of historical data from the time of receiving the trigger. As a non-limiting example, if the trigger is an incident corresponding to a predicted server outage, then the RCA pipeline 102 pulls or extracts data such as but not limited to events, logs, traces, incidents, changes, metrics, and alerts from the data pipeline 104. The data pipeline 104 pulls the data from various sources for consumption by the RCA pipeline 102. As a non-limiting example, the data may be pulled by the RCA pipeline 102 from a log collection process framework or a data service in response to a request to receive the data. The data pulled may include but is not necessarily limited to data pertaining to incidents, alerts, and available raw logs; data for metrics pertaining to CPU usage, memory usage, memory swap, capacity used, availability data, system processes etc.; data for operating system (OS) (e.g., WINDOWS) logs and application logs; and data for system processes and telemetry events.

For metrics (such as CPU usage, memory usage, memory swap, capacity usage, availability data, and system processes) and OS logs, the data pipeline 104 may buffer the most recent data for a predefined time such as but not limited to four hours of data. Other data such as alerts, incidents, available raw logs, and telemetry events may be fed continuously to the data pipeline 104. The data, such as mentioned above, is loaded into a database of the data pipeline 104 for real-time consumption by the RCA pipeline 102.

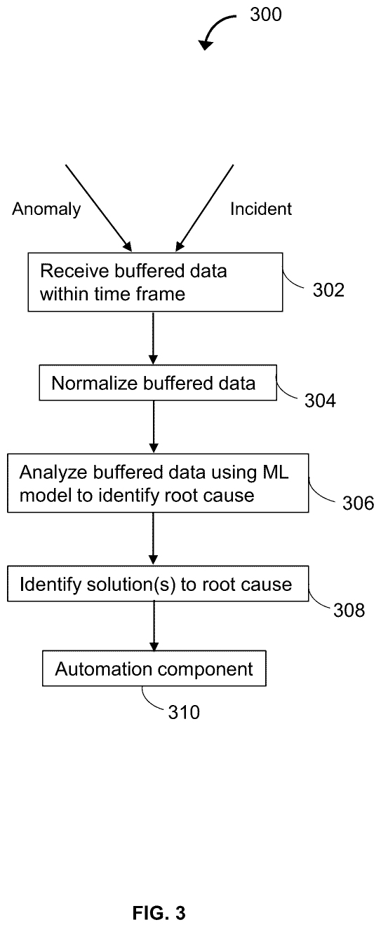

The RCA pipeline 102 includes a machine learning (ML) model to implement RCA technique. The RCA pipeline 102 may automatically consolidate all the investigative data from the data pipeline 104 and prescribe remediation, such as bot(s), for resolution. Operations gain efficiencies by simply verifying the recommendations, performing action, and providing feedback, hence reducing Mean time to recovery (MTTR) tremendously. The details of the ML model and its application is described in FIG. 3. The real-time RCA is built upon a function that consumes the received data to generate various tables in an RCA output 106. In an embodiment, the RCA output 106 may correspond to a database. The RCA output 106 may include information about the configuration item (CI), the CI identifier, RCA timestamp, component availability, performance and capacity metrics showing the health of the component, related events, incidents and changes applied to the component, and the recommended bots for self-healing or actions for problem resolution. Each RCA output 106 includes a CI record for each real time RCA execution. This table contains information pertaining to component of interest such as the server. The detailed information may pertain to availability, CPU usage, memory usage, memory swap, alerts, system logs, application logs, and events.

In an embodiment, above-mentioned tables of the RCA output 106 may be generated using automation and may be accessible in a visualization portal 110. The visualization portal 110 may display RCA recommendations in real time on a portal that may be utilized by IT personnel to verify the recommendations (e.g., bots to be applied, probable root cause) and determine alternate bots to be used for problem resolution. Such feedback from the IT personnel may be captured in form of a human validation input, which is used to automatically self-train the ML model 112 that powers RCA. Thus, the ability to self-train and optimize the ML RCA model 112 using human intervention is called as “Human in the loop” (HITL) as depicted by block 111. As a result of using HITL to automatically self-train the ML RCA model 112, better recommendations may be provided for every subsequent RCA conducted via the self-trained ML RCA model 112.

In an embodiment, the RCA may include real time RCA that is discussed above for the received input triggers such as incidents and anomalies, and batch RCA where a batch job is executed on a regular basis to generate RCA output, similar to that in real time RCA, for incidents that include a CI. The batch RCA may be conducted at a specific time by pulling data from various sources to conduct RCA for regular monitoring of potential defects or failures.

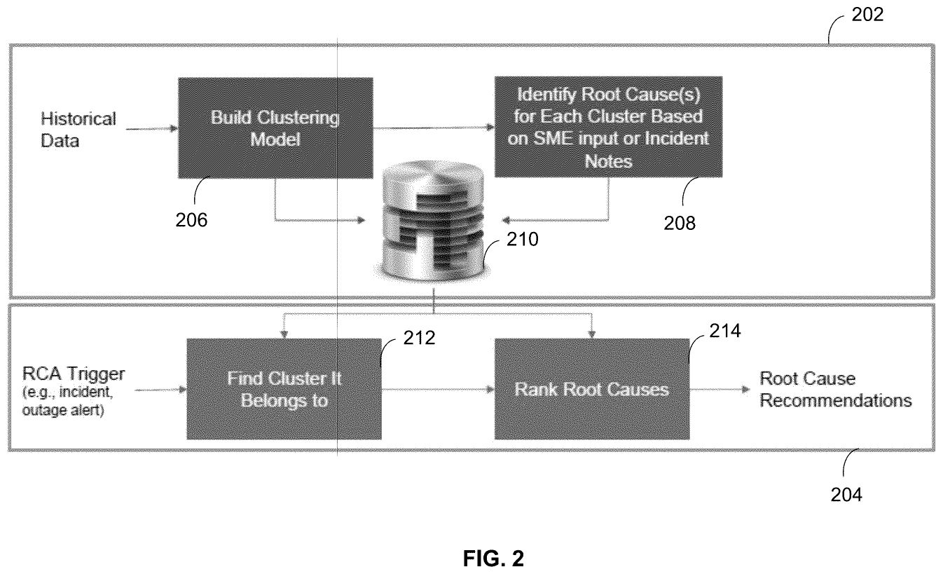

FIG. 2 shows an embodiment of conducting RCA using the ML model. FIG. 2 is explained in conjunction with FIG. 1. The ML model is a part of the RCA pipeline 102 discussed in FIG. 1. The ML model is built and trained, and then the trained ML model is utilized to conduct RCA on real time incoming data.

Referring to FIG. 2, two phases of implementing RCA technique on given set of data include a training phase 202 and a real time phase 204. The training phase 202 comprises a first step to build a clustering model 206. The clustering model 206 may be built based on historical data which is received from the data pipeline 104.

In an exemplary scenario, the historical data fetched from the data pipeline 104 in response to received trigger (such as an incident for a predicted server outage) may include a number of downtimes, a number of cluster OS (such as WINDOWS), system and application events, and a time window prior to downtime. To build or train the ML RCA model 206, cluster analysis is applied to the historical data. In the cluster analysis, clustering is applied to identify major patterns in the events occurring in the time window before downtime.

A non-limiting example of historical data could be 43 downtimes and 137 events during a four-hour time span. The time window of four hours is normalized or divided into smaller intervals, such as 30-minute intervals resulting in eight time points. Thus, for each downtime, a multi-dimensional matrix is created with eight rows (time) and 137 columns (events), where the row indicates time window and column indicates event identifiers. Since the historical data includes downtimes and OS events spanned over different time instances in the time window, the historical data due to being high-dimensional can be represented as a 3-mode tensor. The 3-mode tensor may be very sparse, with less than 2% non-zero entities. For instance, a tensor X may have shape (I, J, K) where, I corresponds to number of downtimes (43 in this example), J corresponds to number of time windows (8 in this example), and K corresponds to number of OS events (137 in this example). After representing the historical data as tensor X, tensor decomposition is performed. As a non-limiting example, tucker decomposition may be applied as a type of tensor decomposition to obtain latent or undetected factors of tensor X. In the tucker decomposition, the tensor X is decomposed into a set of factor matrices (such as A, B, and C) and one small core tensor (such as G) which controls the scaling applied to each factor matrix. Subsequently, clustering using any clustering algorithm (such as but not limited to k-means) is applied on an output of the tucker decomposition (such as on factor matrix A). In this example, a result of the clustering reveals eight group of clusters for 43 downtimes, where five clusters are identified to have more than one downtime. A cluster is typically identified based on a common pattern or common characteristics exhibited by one or more events. Further, the identified clusters may be mutually exclusive or overlapping.

Therefore, the clusters are identified for each pattern as a result of applying the clustering algorithm to the output of the tensor/tucker decomposition in the training phase 202 of the clustering model 206. As a next block 208 in the training phase 202, root cause(s) for each of the identified clusters are identified. As a non-limiting example, the root cause(s) for each cluster may be identified by one or more subject matter experts (SMEs) who manually label or identify each cluster and confirm their root cause(s). As another non-limiting example, the root cause(s) for each cluster may be identified based on resolution information available in notes of solutioning team or service engineer(s) who resolved the (historical) incidents. Accordingly, an output of the training phase 202 is a trained ML model including a library 210 of clusters and their corresponding root causes, where each cluster corresponds to a pattern. The trained ML model utilizes the library 210 for real-time RCA in the real time phase 204.

With reference to FIG. 2, for the RCA trigger (e.g., predicted/detected incident or anomaly) received by the RCA pipeline 102, a cluster is identified at block 212 in the real time phase 204 by utilizing the trained ML model including the library 210. Subsequently, one or more root causes are extracted pertaining to the identified cluster and the one or more root causes are ranked in an order at block 214. Based on the ranked root cause(s), one or more root cause recommendations or solutions are identified and provided by the trained ML model as an output of the RCA pipeline 102. The root cause recommendations or solutions are identified based on characteristics associated with the root cause(s) of the trigger (anomaly, detected incident, or predicted incident corresponding to predicted outage of a component).

In an embodiment, the recommendations or diagnosis of the RCA trigger, incident (predicted or detected) or the anomaly, may be learned by the clustering model 206 during the training phase 202 as a result of SME validation on the solution(s) or resolution information recorded by the IT personnel. The clustering model 206 may be trained to understand a correlation between cluster, root cause(s), and solution(s) during the training phase 202 which may be utilized while providing recommendation(s) in the real time phase 204.

In another embodiment, providing root cause recommendation(s) or solution(s) may include triggering an automation component. For instance, the provided recommendation may include automatically executing a set of instructions to run a pre-existing bot, among a plurality of pre-existing bots, to avoid the predicted incident. As a non-limiting example, the predicted incident may correspond to problem such as predicted server outage. Accordingly, the predicted problem for which the incident functioned as a trigger can be prevented using the automation component or automatic execution of the above-mentioned instructions. Such a solution is self-healing or self-remediating or auto-remediating, thereby without requiring manual intervention.

In yet another embodiment, providing root cause recommendation(s) or solution(s) may include providing recommendation(s) or solution(s) to a service engineer who is assigned to fix the problem, whether detected or predicted. The recommendations may be provided in ranked manner, allowing the service engineer to check the best solution among the recommendations in order of priority in which they are presented. This approach would aid the service engineer in quick turnaround time for resolution as all the root cause(s) associated with the problem would be available with the service engineer along with one or more recommendations due to the RCA conducted with the present embodiments instead of manually performing each step of RCA. Further, the service engineer may view all the recommendations or solutions suggested by the RCA pipeline 102 on a dashboard provided by the visualization portal 110 which may further reduce mean time to investigation (MTTI) and MTTR. The above embodiments for providing the root cause recommendation(s) or solution(s) by the RCA pipeline 102 may be implemented exclusively or in combination.

FIG. 3 shows a flowchart 300 of an embodiment for using the ML model for RCA to provide solutions. FIG. 3 is explained in conjunction with previous figures. The RCA method disclosed according to the embodiments of the present disclosure is proactive in taking actions before a predicted problem occurs in relation to a component of a system. The proactive RCA method begins when a trigger input such as an anomaly or an incident corresponding to the predicted problem is received. The trigger input may be associated with information or data that identifies the anomaly or incident. Such information may include an identifier to determine the type of data to be pulled while conducting the RCA.

The RCA method begins at block 302 once the RCA trigger in form of anomaly or incident is received. In response to the RCA trigger, a data service is requested for buffered data generated by the component of the system within a specific time frame of receiving the trigger input information. As a non-limiting example, buffered data may include data pertaining to events, metrics, performance telemetry, system capacity telemetry, logs, metrics, messages, incidents, and alerts. In an exemplary scenario, if the incident corresponding to a predicted server outage is the RCA trigger, then from a data processing pipeline such as Logstash, buffered or historical data generated by the server is accessed for last four hours before the server outage is predicted to happen.

The buffered data received is then normalized at block 304. Data normalization may refer to organizing the buffered data in a specific format for further analysis. The buffered data received for the specific time frame from the data service may be normalized into discrete time units and further into corresponding distinct units of time.

At block 306, the buffered data is analyzed using the ML model to identify one or more root causes of the anomaly or incident. The ML model is built for performing the RCA method according to the present disclosure in such a way that disparate historical data related to the trigger is collected, analyzed, decomposed, and clustered to identify clusters corresponding to patterns.

In a non-limiting example, as the buffered data includes high-dimensional data, it is represented as a 3-D tensor or a 3-D matrix. Subsequently, tensor decomposition technique may be applied to obtain latent or undetected factors of the tensor followed by performing clustering. A clustering algorithm, such as by using k-means clustering algorithm, is applied on an obtained factor matrix to identify clusters or uniform groups. Once the clusters are identified, either by using notes of previously resolved incidents/problems or input from SMEs, one or more root causes corresponding to each cluster are identified. As a result, the ML model is trained to identify the clusters and their corresponding root causes for the buffered data that was associated with the component or CI corresponding to the trigger. The trained ML model, in turn, identifies one or more root causes of the anomaly or incident by finding a cluster that the anomaly or incident belongs to among the previously identified clusters.

At block 308, one or more solutions to the root cause(s) of the anomaly or predicted incident are identified based on characteristics associated with the root cause of the anomaly or the predicted incident. In a non-limiting example, the ML model may be trained to identify one or more solutions corresponding to each of the identified clusters and associated root causes during the training phase. The identification of one or more solutions may be realized either by referring to notes of previously resolved incidents/problems that may indicate solution(s) for each root cause/cluster or by seeking input from SMEs to manually identify solution(s) for root cause(s). Accordingly, the one or more solutions to the root cause(s) of the RCA trigger may be readily identified.

Once the one or more solutions to the root cause(s) of the anomaly or predicted incident are identified, then at block 310, at least one solution may be provided to an automation component in case one of the identified solutions indicate auto-remediation or self-healing. Auto-remediation or self-healing refers to a functionality of the system to remediate any detected or predicted problem using automation without human intervention. In a non-limiting example, one of the identified solutions may include executing an available set of instructions that is known to resolve the predicted problem. As a result, the RCA method according to the present embodiment avoids onset of an event that triggers outage of the component or the system by providing automation solution.

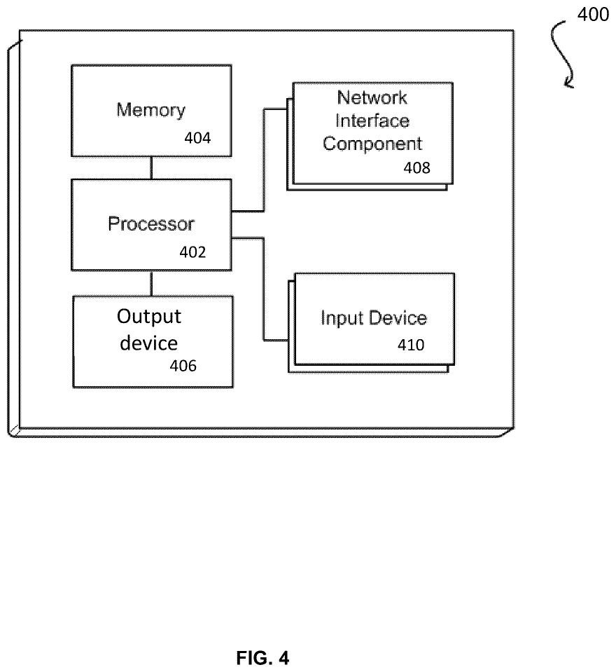

FIG. 4 shows an example of a computing system 400 for implementing a method that conducts RCA using the ML model. The computing system 400 includes computerized devices, each such device can include hardware elements that may be electrically coupled via a bus, the elements include at least one processor (central processing unit (CPU) or processing unit) 402, that is communicatively coupled to other elements of the computing system 400 such as a memory 404, an output device 406, a network interface component 408, and an input device 410. The processor 402 can include any general-purpose processor as well as a special-purpose processor where software instructions are incorporated into the actual processor design. The processor 402 may essentially be a completely self-contained computing system, containing multiple cores or processors, a bus, memory controller, cache, etc. A multi-core processor may be symmetric or asymmetric.

The memory 404 may include one or more storage devices, such as disk drives, optic storage devices, and solid-state storage devices such as random-access memory (“RAM”) or read-only memory (“ROM”), as well as removable media devices, memory cards, flash cards, etc. The memory 404 may also be a storage media and a computer readable media that contains code, or portions of code, can include any appropriate media known or used in the art. The storage media and communication media are, but not limited to, volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optic storage, magnetic cassettes, magnetic tape, magnetic disk storage or other magnetic storage devices, or any other medium which can be used to store the desired information and which can be accessed by a system device or the processor 402.

The storage media may be coupled to other devices of the computing system 400, such as a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information.

An environment including the computing system 400 can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate.

The computing system 400 includes at least one input device 410 (e.g., a mouse, keyboard, controller, touch screen, or keypad), and at least one output device 406 (e.g., a display device, printer, or speaker). The network interface component 408 supports communication between the computing system 400 other external systems or devices. Most embodiments utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In an embodiment, the computerized device includes a Web server (not shown), the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The computing system 400 may be implemented in a serverless computing environment and/or cloud computing environment such as but not limited to Amazon's AWS, Microsoft's Azure, Google cloud, OpenStack, local docker environment (e.g., private cloud with support for implementing containers), local environment (e.g., private cloud) with support for virtual machines or microservices, and the like.

The computing system 400 and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Various embodiments discussed or suggested herein can be implemented in a wide variety of operating environments, which in some cases can include one or more user computers, computing devices, or processing devices which can be used to operate any of a number of applications. User or client devices can include any of a number of general-purpose individual computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network. Based on the disclosure and teachings provided herein, an individual of ordinary skill in the art will appreciate other ways and/or methods to implement the various embodiments.

The specification and drawings are to be regarded in an illustrative rather than a restrictive sense. It will, however, be evident that various modifications and changes may be made thereunto without departing from the broader spirit and scope of the invention as set forth in the claims.

We claim:

1. A method, comprising:
receiving information identifying an anomaly or a predicted outage of a component of a system;
requesting a data service for buffered data generated by the component of the system within a timeframe of receiving the information;
normalizing the buffered data into discrete time units into corresponding distinct units of time;
analyzing the buffered data using a machine learning (ML) model to identify a root cause of the anomaly or the predicted outage;
identifying at least one solution to the root cause of the anomaly or the predicted outage based on characteristics associated with the root cause of the anomaly or the predicted outage; and
in response to the anomaly or the predicted outage, providing the at least one solution to an automation component to avoid onset of an event that triggers outage of the component or the system.

2. The method of claim 1, further comprising:
normalizing events associated with an application or the system in the buffered data that are identified by a unique key,
wherein analyzing the buffered data using the ML model identifies undetected characteristics associated with the events that are normalized over normalized time.

3. The method of claim 1, wherein the ML model is configured to cluster the buffered data into a plurality of clusters and select a cluster based on characteristics associated with the cluster that identifies the root cause of the anomaly or the predicted outage.

4. The method of claim 3, further comprising:
receiving a report based on resolution of an issue, the report including metrics and other information stored in the data service and identifying a root cause that corresponds to at least one clusters of the plurality of clusters;
updating a training dataset based on the report; and
training an updated ML model based on the training dataset and an evaluation dataset.

5. A non-transitory computer readable media storing instructions programmed to cooperate with a processor to perform operations comprising:
receiving information identifying an anomaly or a predicted outage of a component of a system;
requesting a data service for buffered data generated by the component of the system within a timeframe of receiving the information;
normalizing the buffered data into discrete time units into corresponding distinct units of time;
analyzing the buffered data using a machine learning (ML) model to identify a root cause of the anomaly or the predicted outage;
identifying at least one solution to the root cause of the anomaly or the predicted outage based on characteristics associated with the root cause of the anomaly or the predicted outage; and
in response to the anomaly or the predicted outage, providing the at least one solution to an automation component to avoid onset of an event that triggers outage of the component or the system.

6. The non-transitory computer readable media of claim 5, the operations further comprising:
normalizing events associated with an application or the system in the buffered data that are identified by a unique key,
wherein analyzing the buffered data using the ML model identifies undetected characteristics associated with the events that are normalized over normalized time.

7. The non-transitory computer readable media of claim 5, wherein the ML model is configured to cluster the buffered data into a plurality of clusters and select a cluster based on characteristics associated with the cluster that identifies the root cause of the anomaly or the predicted outage.

8. The non-transitory computer readable media of claim 7, the operations further comprising:
receiving a report based on resolution of an issue, the report including metrics and other information stored in the data service and identifying a root cause that corresponds to at least one clusters of the plurality of clusters;
updating a training dataset based on the report; and
training an updated ML model based on the training dataset and an evaluation dataset.

9. A system, comprising:
a non-transitory computer readable media storing instructions;
a processor programmed to cooperate with the instructions to perform operations comprising:
receiving information identifying an anomaly or a predicted outage of a component of a system;
requesting a data service for buffered data generated by the component of the system within a timeframe of receiving the information;
normalizing the buffered data into discrete time units into corresponding distinct units of time;
analyzing the buffered data using a machine learning (ML) model to identify a root cause of the anomaly or the predicted outage;
identifying at least one solution to the root cause of the anomaly or the predicted outage based on characteristics associated with the root cause of the anomaly or the predicted outage; and
in response to the anomaly or the predicted outage, providing the at least one solution to an automation component to avoid onset of an event that triggers outage of the component or the system.

10. The system of claim 9, the operations further comprising:
normalizing events associated with an application or the system in the buffered data that are identified by a unique key,
wherein analyzing the buffered data using the ML model identifies undetected characteristics associated with the events that are normalized over normalized time.

11. The system of claim 9, wherein the ML model is configured to cluster the buffered data into a plurality of clusters and select a cluster based on characteristics associated with the cluster that identifies the root cause of the anomaly or the predicted outage.

12. The system of claim 11, the operations further comprising:
receiving a report based on resolution of an issue, the report including metrics and other information stored in the data service and identifying a root cause that corresponds to at least one clusters of the plurality of clusters;
updating a training dataset based on the report; and
training an updated ML model based on the training dataset and an evaluation dataset.
